(19) United States
(12) Patent Application Publication
(10) Pub. No.: US 2013/0271491 A1
(43) Pub. Date: Oct. 17, 2013

(54) LOCAL SENSOR AUGMENTATION OF STORED CONTENT AND AR COMMUNICATION

(71) Applicant: Glen J. Anderson, Portland, OR (US)

(72) Inventor: Glen J. Anderson, Portland, OR (US)

(21) Appl. No.: 13/977,581

(22) PCT Filed: Dec. 20, 2011
(86) PCT No.: PCT/US11/66269

§ 371 Date: Jun. 28, 2013

(51) Int. Cl. G06T 11/60

(52) U.S. Cl. CPC G06T 11/60
USPC 345/633

(57) ABSTRACT

The augmentation of stored content with local sensors and AR communication is described. In one example, the method includes gathering data from local sensors of a local device regarding a location, receiving an archival image at the local device from a remote image store, augmenting the archival image using the gathered data, and displaying the augmented archival image on the local device.

### BACKGROUND

Mobile Augmented Reality (MAR) is a technology that can be used to apply games to existing maps. In MAR, a map or satellite image can be used as a playing field and other players, obstacles, targets, and opponents are added to map. Navigation devices and applications also show a user's position on a map using a symbol or an icon. Geocaching and treasure hunt games have also been developed which show caches or clues in particular locations over a map.

These techniques all use maps that are retrieved from a remote mapping, locating, or imaging service. In some cases the maps show real places that have been photographed or charted while in other cases the maps may be maps of fictional places. The stored maps may not be current and may not reflect current conditions. This may make the augmented reality presentation seem unrealistic, especially for a user that is in the location shown on the map.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is diagram of a real scene from a remote image store suitable for AR representations according to an embodiment of the invention.

FIG. 2 is diagram of the real scene of FIG. 1 showing real objects augmenting the received image according to an embodiment of the invention.

FIG. 3 is diagram of the real scene of FIG. 1 showing real objects enhanced by AR techniques according to an embodiment of the invention.

FIG. 4 is diagram of the real scene of FIG. 1 showing virtual objects controlled by the user according to an embodiment of the invention.

FIG. 5 is diagram of the real scene of FIG. 4 showing virtual objects controlled by the user and a view of the user according to an embodiment of the invention.

FIG. 6 is a process flow diagram of augmenting an archival image with virtual objects according to an embodiment of the invention.

FIG. 7A is a diagram of a real scene from a remote image store augmented with a virtual object according to another embodiment of the invention.

FIG. 7B is a diagram of a real scene from a remote image store augmented with a virtual object and an avatar of another user according to another embodiment of the invention.

FIG. 8 is block diagram of a computer system suitable for implementing processes of the present disclosure according to an embodiment of the invention.

FIG. 9 is a block diagram of a an alternative view of the computer system of FIG. 8 suitable for implementing processes of the present disclosure according to an embodiment of the invention.

### DETAILED DESCRIPTION

Portable devices, such as cellular telephones and portable media players offer many different types of sensors that can be used to gather information about the surrounding environment. Currently these sensors include positioning system satellite receivers, cameras, a clock, and a compass, additional sensors may be added in time. These sensors allow the device to have situational awareness about the environment. The device may also be able to access other local information including weather conditions, transport schedules, and the presence of other users that are communicating with the user.

This data from the local device may be used to make an updated representation on a map or satellite image that was created at an earlier time. The actual map itself may be changed to reflect current conditions.

In one example, a MAR game with satellite images is made more immersive by allowing users to see themselves and their local environment represented on a satellite image in the same way as they appear at the time of playing the game. Other games with stored images, other than satellite images, may also be made more immersive.

Stored images or archival images or other stored data drawn from another location, such as satellite images may be augmented with local sensor data to create a new version of the image that looks current. There are a variety of augmentations that may be used. People that are really at that location or moving vehicles may be shown, for example. The view of these people and things may be modified from the sensor version to show them from a different perspective, the perspective of the archival image.

In one example, satellite images from for example, Google Earth™ may be downloaded based on the user's GPS (Global Positioning System) position. The downloaded image may then be transformed with sensor data that is gathered with a user's smart phone. The satellite images and local sensor data may be brought together to create a realistic or styled scene within a game, which is displayed on the user's phone. The phone's camera can acquire other people, the color of their clothes, lighting, clouds, and nearby vehicles. As a result, within the game, the user can virtually zoom down from a satellite and see a representation of himself or herself or friends who are sharing their local data.

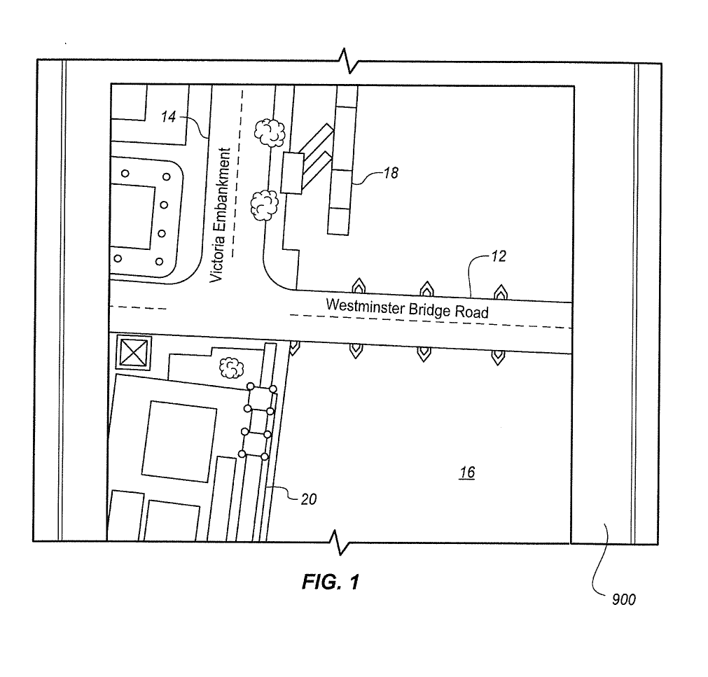

FIG. 1 is a diagram of an example of a satellite image downloaded from an external source. Google Inc. provides such images as do many other Internet sources. The image may be retrieved as it is needed or retrieved in advance and then read out of local storage. For games, the game supplier may provide the images or provide a link or connection to an alternate source of images that may be best suited for the game. This image shows Westminster Bridge Road 12 near the center of London England and its intersection with the Victoria Embankment 14 near Westminster Abbey. The water of the Thames River 16 lies beneath the bridge with the Millennium Pier 18 on one side of the bridge and the Parliament buildings 20 on the other side of the bridge. This image will show the conditions at the time that the satellite image was taken, which was in broad daylight and may be any day of any season within the last five or maybe even ten years.

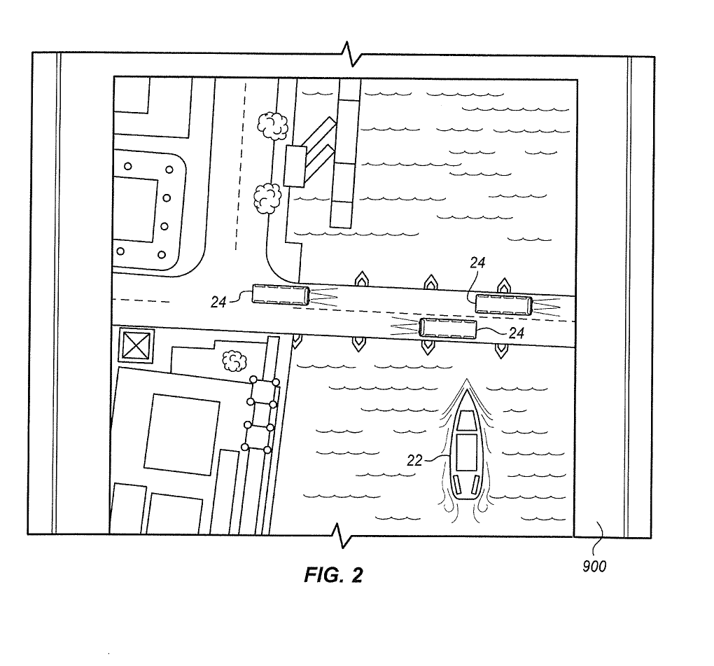

FIG. 2 is a diagram of the same satellite image as shown in FIG. 1 with some enhancements. First, the water of the Thames River has been augmented with waves to show that it is a windy day. There may be other environmental enhancements that are difficult to show in a diagram, such as light or darkness to show the time of day and shadows along the bridge towers and other structures, trees and even people to indicate the position of the sun. The season may be indicated by green or fall leaf colors or bareness on the trees. Snow or rain may be shown on the ground or in the air, although snow is not common in this particular example of London.

In FIG. 2, the diagram has been augmented with tour buses 24. These busses may have been captured by the camera of the user's smart phone or other device and then rendered as real objects in the real scene. They may have been captured by the phone and then augmented with additional features, such as colors, labels, etc as augmented reality objects. Alternatively, the buses may have been generated by the local device for some purpose of a program or display. In a simple example, the tour bus may be generated on the display to show the route that a bus might take. This could aid the user in deciding whether to purchase a tour on the bus. In addition, the buses are shown with bright headlight beams to indicate that it is dark or becoming dark outside. A ship 22 has also been added to the diagram. The ship may be useful for game play for providing tourism or other information or for any other purpose.

The buses, ships, and water may also be accompanied with sound effects played through speakers of the local device. The sounds may be taken from memory on the device or received through a remote server. Sound effects may include waves on the water, bus and ship engines, tires, and horns and even ambient sounds such as flags waving, generalized sounds of people moving and talking, etc.

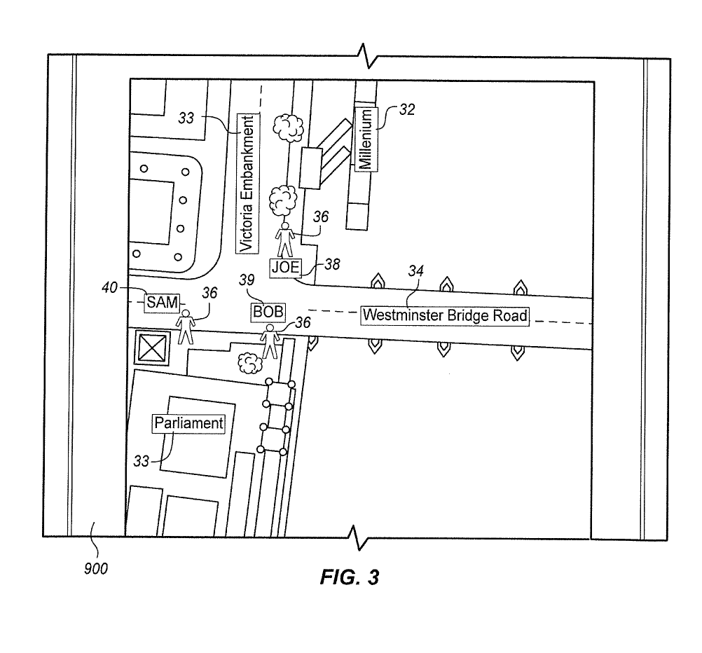

FIG. 3 is a diagram of the same satellite map showing other augmentations. The same scene is shown without the augmentations of FIG. 2 in order to simplify the drawing, however, all of the augmentations described herein may be combined. The image shows labels for some of the objects on the map. These include a label 34 on the road as Westminster Bridge Road, a label 32 on the Millennium Pier, and a label 33 on the Victoria Embankment and Houses of Parliament. These labels may be a part of the archival image or may be added by the local device.

In addition, people 36 have been added to the image. These people may be generated by the local device or by game software. In addition, people may be observed by a camera on the device and then images, avatars, or other representations may be generated to augment the archival image. An additional three people are labeled in the figures as Joe 38, Bob 39, and Sam 40. These people may be generated in the same way as the other people. They may be observed by the camera on the local device, added to the scene as an image, avatars, or as another type of representation and then labeled. The local device may recognize them using face recognition, user input, or in some other way.

As an alternative, these identified people may send a message from their own smart phones indicating their identity. This might then be linked to the observed people. The other users may also send location information, so that the local device adds them to the archival image at the identified location. In addition, the other users may send avatars, expressions, emoticons, messages or any other information that the local device can use in rendering and labeling the identified people 38, 39, 40. When the local camera sees these people or when the sent location is identified, the system may then add the renderings in the appropriate location on the image. Additional real or observed people, objects, and things may also be added. For example augmented reality characters may also be added to the image, such as game opponents, resources, or targets.

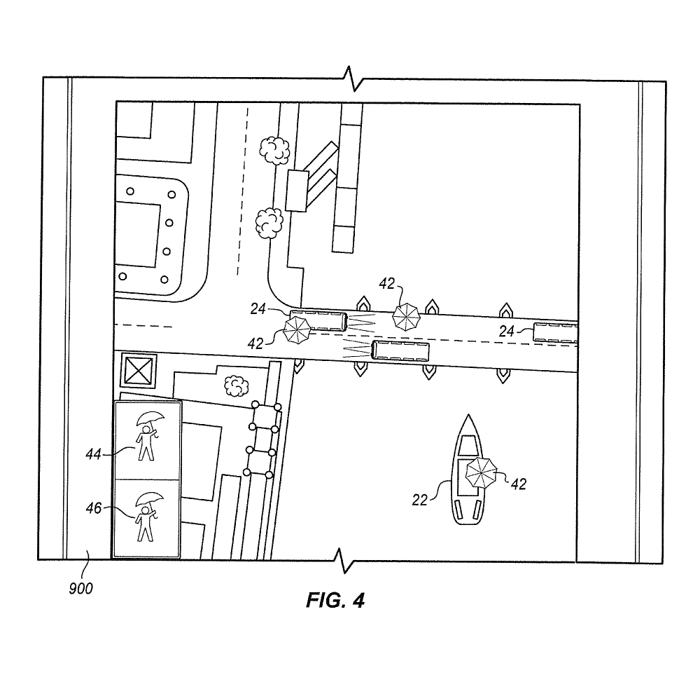

FIG. 4 shows a diagram of the same archival image of FIG. 1 augmented with virtual game characters 42. In the diagram of FIG. 4, augmented reality virtual objects are generated and applied to the archived image. The objects are selected from a control panel at the left side of the image. The user selects from different possible characters 44, 46, in this case umbrella carrying actors and then drops them on various objects such as the buses 24, the ship 22 or various buildings. The local device may augment the virtual objects 42 by showing their trajectory, action upon landing on different objects and other effects. The trajectory can be affected by actual weather conditions or by virtual conditions generated by the device. The local device may also augment the virtual objects with sound effects associated with falling, landing, and moving about after landing.

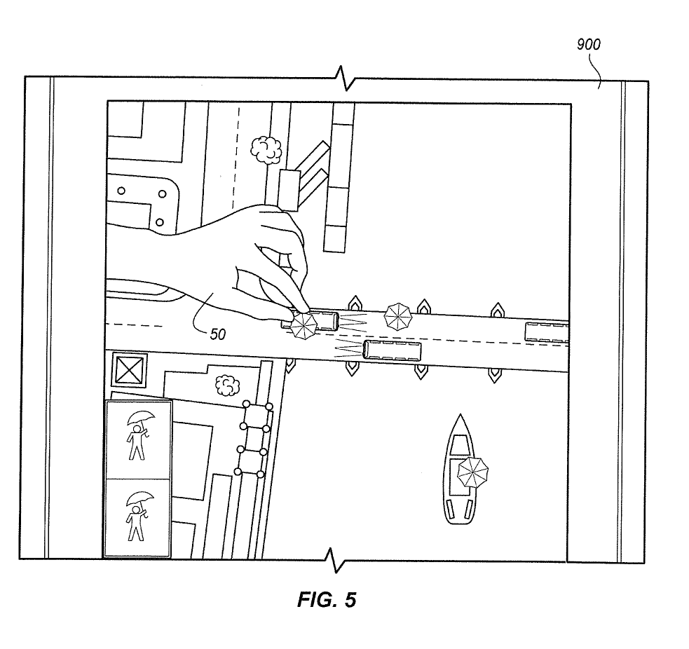

FIG. 5 shows an additional element of game play in a diagram based on the diagram of FIG. 4. In this view, the user sees his hand 50 in the sky over the scene as a game play element. In this game, the user drops objects onto the bridge below. The user may actually be on the bridge, so the camera on the user's phone has detected the buses. In a further variation, the user could zoom down further and see a representation of himself and the people around him.

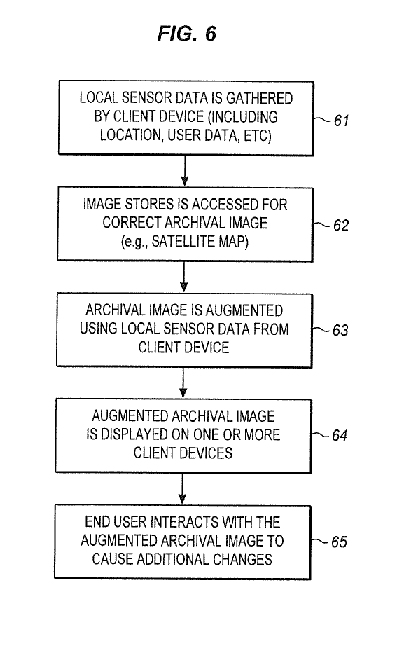

FIG. 6 is a process flow diagram of augmenting an archival map as described above according to one example. At 61 local sensor data is gathered by the client device. This data may include location information, data about the user, data about other nearby users, data about environmental conditions, and data about surrounding structures, objects and people. It may also include compass orientation, attitude, and other data that sensors on the local device may be able to collect.

At 62, an image store is accessed to obtain an archival image. In one example, the local device determines its position using GPS or local Wi-Fi access points and then retrieves an image corresponding to that position. In another example, the local device observes landmarks at its position and obtains an appropriate image. In the example of FIG. 1, the Westminster Bridge and the parliament buildings are both distinctive structures. The local device or a remote server may receive images of one or both of these structures, identifies them and then returns appropriate archival images for that location. The user may also input location information or correct location information for retrieving the image.

At 63, the obtained image is augmented using data from sensors on the local device. As described above, the augmentation may include modification for time, date, season, weather conditions, and point of view. The image may also be augmented by adding real people and objects observed by the local device as well as virtual people and objects generated by the device or sent to the device from another user or software source. The image may also be augmented with sounds. Additional AR techniques may be used to provide labels and metadata about the image or a local device camera view.

At 64, the augmented archival image is displayed on the local device and sounds are played on the speakers. The augmented image may also be sent to other user's devices for display so that those users can also see the image. This can provide an interesting addition for a variety of types of game play including geocaching and treasure hunt types of games. At 65, the user interacts with the augmented image to cause additional changes. Some examples of this interaction are shown in FIGS. 4 and 5, however a wide range of other interactions are also possible.

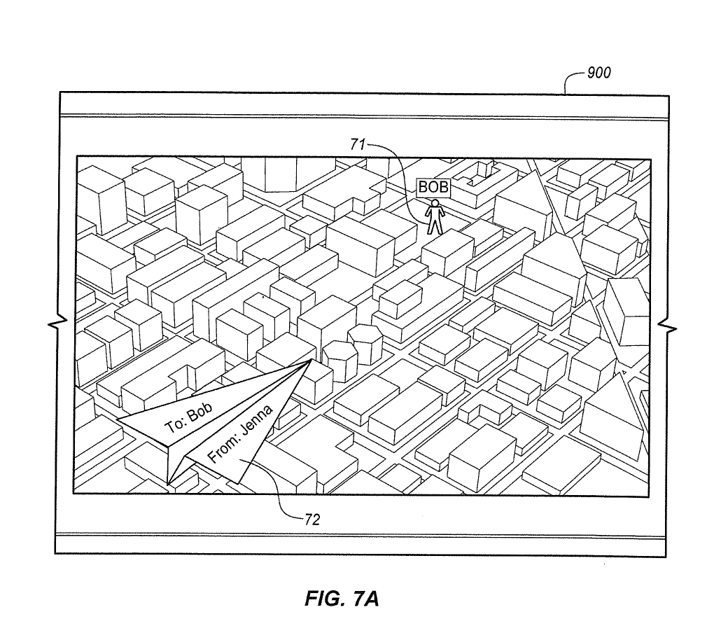

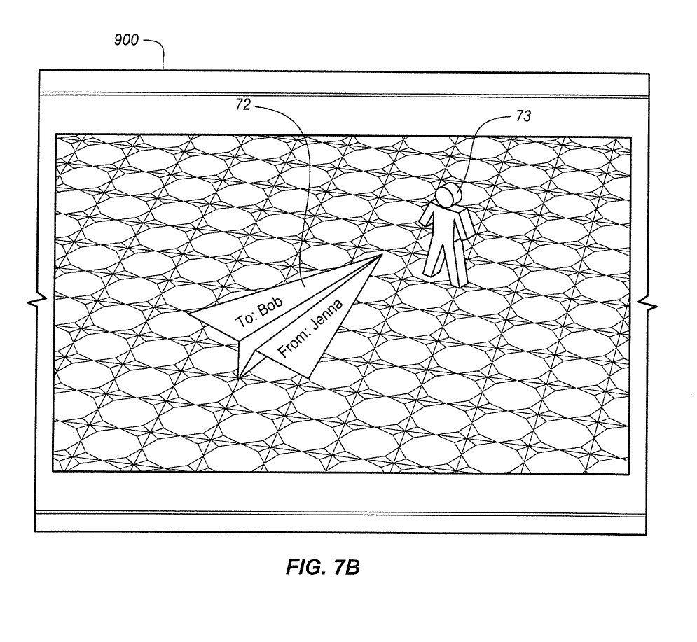

FIG. 7A shows another example of an archival image augmented by the local device. In this example, a message 72 is sent from Bob to Jenna. Bob has sent an indication of his location to Jenna and this location has been used to retrieve an archival image of an urban area that includes Bob's location. Bob's location is indicated by a balloon 71. The balloon may be provided by the local device or by the source of the image. As in FIG. 1, the image is a satellite image with street and other information superimposed. The representation of Bob's location may be rendered as a picture of Bob, an avatar, an arrow symbol, or in any other way. The actual position of the location representation may be changed if Bob sends information that he has moved or if the local device camera observes Bob's location as moving.

In addition to the archival image and the representation of Bob, the local device has added a virtual object 72, shown as a paper airplane, however, it may be represented in many other ways instead. The virtual object in this example represents a message, however, it may represent many other objects instead. For game play, as an example, the object may be information, additional munitions, a reconnaissance probe, a weapon, or an assistant. The virtual object is shown traveling across the augmented image from Jenna to Bob. As an airplane it flies over the satellite image. If the message were indicated as a person or a land vehicle, then it may be represented as traveling along the streets of the image. The view of the image may be panned, zoomed, or rotated as the virtual object travels in order to show its progress. The image may also be augmented with sound effects of the paper airplane or other object as it travels.

In FIG. 7B, the image has been zoomed as the message comes close to its target. In this case Bob is represented using an avatar 73 and is shown as ready to catch the message 72. A sound effect of catching the airplane and Bob making a vocal response may be played to indicate that Bob has received the message. As before, Bob can be represented in any of a variety of different realistic or fanciful ways. The archival image may be a zoomed in satellite map, or as in this example, a photograph of a paved park area that coincides with Bob's location. The photograph may come from a different source, such as a web site that describes the park. The image may also come from Bob's own smart phone or similar device. Bob may take some photographs of his location and send those to Jenna. Jenna's device may then display those augmented by Bob and the message. The image may be further enhanced with other characters or objects both virtual and real.

As described above, embodiments of the present invention provide, augmenting a satellite image or any other stored image set with nearly real-time data that is acquired by a device that is local to the user. This augmentation can include any number of real or virtual objects represented by icons or avatars or more realistic representations.

Local sensors on a user's device are used to update the satellite image with any number of additional details. These can include the color and size of trees and bushes and the presence and position of other surrounding object such as cars, buses, buildings, etc. The identity of other people who opt in to share information can be displayed as well as GPS locations, the tilt of a device a user is holding, and any other factors.

Nearby people can be represented as detected by the local device and then used to augment the image. In addition, to the simple representations shown, representations of people can be enhance by showing height, size, and clothing, gestures and facial expressions and other characteristics. This can come from the device's camera or other sensors and can be combined with information provided by the people themselves. Users on both ends may be represented on avatars that are shown with a representation of near real-time expressions and gestures

The archival images may be satellite maps and local photographs, as shown, as well as other stores of map and image data. As an example, internal map or images of building interiors may be used instead or together with the satellite maps. These may come from public or private sources, depending on the building and the nature of the image. The images may also be augmented to simulate video of the location using panning, zooming and tile effects and by moving the virtual and real objects that are augmenting the image.

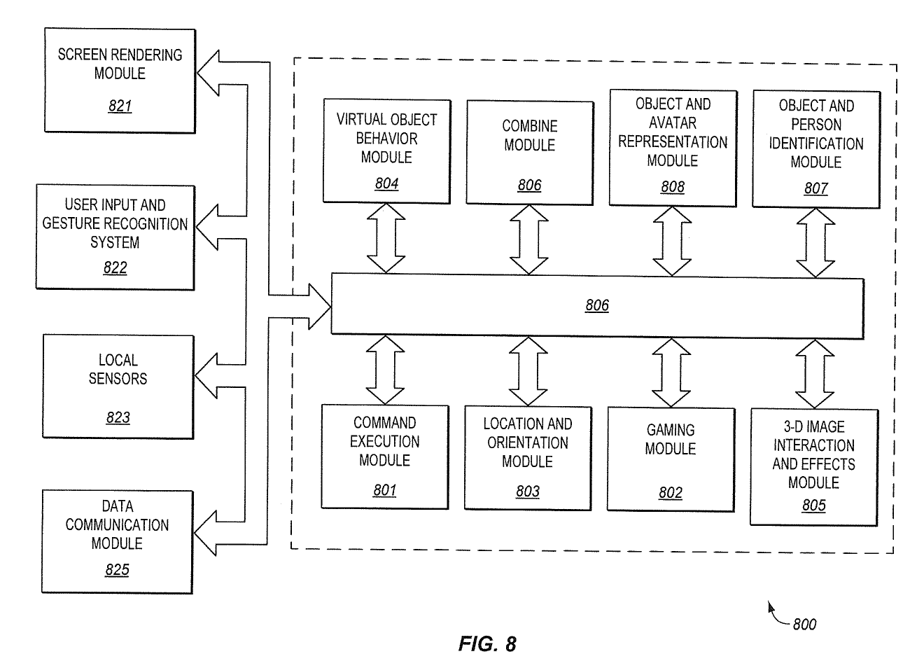

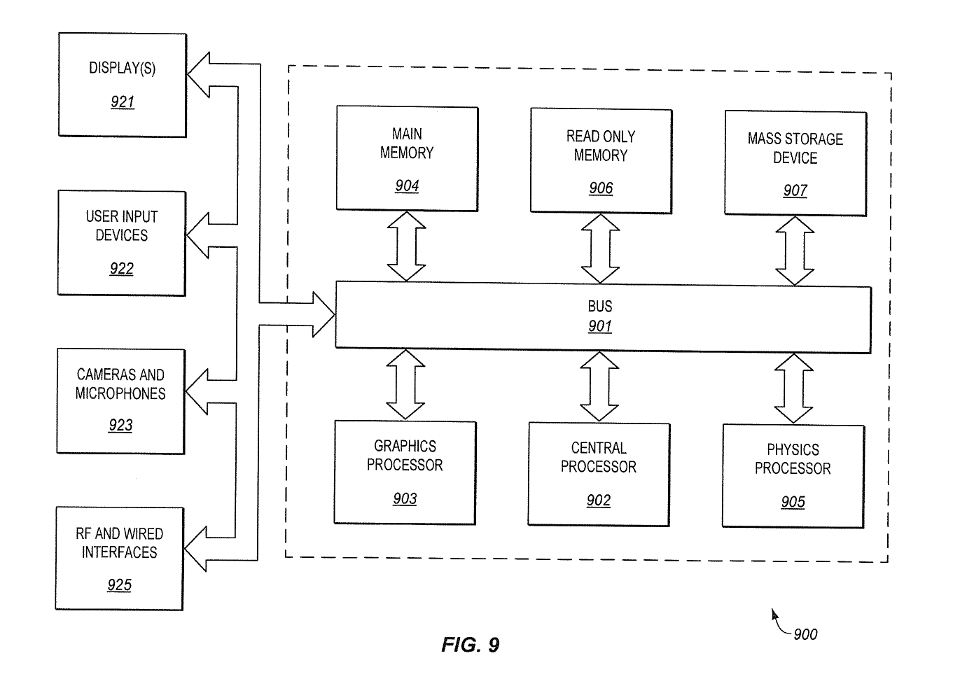

FIG. 8 is a block diagram of a computing environment capable of supporting the operations discussed above. The modules and systems can be implemented in a variety of different hardware architectures and form factors including that shown in FIG. 9.

The Command Execution Module 801 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 821 draws objects on one or more screens of the local device for the user to see. It can be adapted to receive the data from the Virtual Object Behavior Module 804, described below, and to render the virtual object and any other objects on the appropriate screen or screens. Thus, the data from the Virtual Object Behavior Module would determine the position and dynamics of the virtual object and associated gestures, and objects, for example, and the Screen Rendering Module would depict the virtual object and associated objects and environment on a screen, accordingly.

The User Input and Gesture Recognition System 822 may be adapted to recognize user inputs and commands including hand and harm gestures of a user. Such a module may be used to recognize hands, fingers, finger gestures, hand movements and a location of hands relative to displays. For example, the Object and Gesture Recognition Module could for example determine that a user made a gesture to drop or throw a virtual object onto the augmented image at various locations. The User Input and Gesture Recognition System may be coupled to a camera or camera array, a microphone or microphone array, a touch screen or touch surface, or a pointing device, or some combination of these items, to detect gestures and commands from the user.

The Local Sensors 823 may include any of the sensor mentioned above that may be offered or available on the local device. These may include those typically available on a smart phone such as front and rear cameras, microphones, positioning systems, Wi-Fi and FM antennas, accelerometers, and compasses. These sensors not only provide location awareness but also allow the local device to determine its orientation and movement when observing a scene. The local sensor data is provided to the command execution module for use in selecting an archival image and for augmenting that image.

The Data Communication Module 825 contains the wired or wireless data interfaces that allow all of the devices in the system to communicate. There may be multiple interfaces with each device. In one example, the AR display communicates over Wi-Fi to send detailed parameters regarding AR characters. It also communicates over Bluetooth to send user commands and to receive audio to play through the AR display device. Any suitable wired or wireless device communication protocols may be used.

The Virtual Object Behavior Module 804 is adapted to receive input from the other modules, and to apply such input to the virtual object that have been generated and that are being shown in the display. Thus, for example, the User Input and Gesture Recognition System would interpret a user gesture and by mapping the captured movements of a user's hand to recognized movements, the Virtual Object Behavior Module would associate the virtual object's position and movements to the user input to generate data that would direct the movements of the virtual object to correspond to user input.

The Combine Module 806 alters the archival image, such as a satellite map or other image to add information gathered by the local sensors 823 on the client device. This module may reside on the client device or on a “cloud” server. The Combine Module uses data coming from the Object and Person Identification Module 807 and adds the data to images from the image source. Objects and people are added to the existing image. The people may be avatar representations or more realistic representations.

The Combine Module 806 may use heuristics for altering the satellite maps. For example, in a game that allows racing airplanes overhead that try to bomb an avatar of a person or character on the ground, the local device gathers information that includes: GPS location, hair color, clothing, surrounding vehicles, lighting conditions, and cloud cover. This information may then be used to construct avatars of the players, surrounding objects, and environmental conditions to be visible on the satellite map. For example, a user could fly the virtual plane behind a real cloud that was added to the stored satellite image.

The Object and Avatar Representation Module 808 receives information from the Object and Person Identification Module 807 and represents this information as objects and avatars. The module may be used to represent any real object as either a realistic representation of the object or as an avatar. Avatar information may be received from other users, or a central database of avatar information.

The Object and Person Identification Module uses received camera data to identify particular real objects and persons. Large objects such as buses and cars may be compared to image libraries to identify the object. People can be identified using face recognition techniques or by receiving data from a device associated with the identified person through a personal, local, or cellular network. Having identified objects and persons, the identities can then be applied to other data and provided to the Object and Avatar Representation Module to generate suitable representations of the objects and people for display.

The Location and Orientation Module 803 uses the local sensors 823 to determine the location and orientation of the local device. This information is used to select an archival image and to provide a suitable view of that image. The information may also be used to supplement the object and person identifications. As an example, if the user device is located on the Westminster Bridge and is oriented to the east, then objects observed by the camera are located on the bridge. The Object and Avatar Representation Module 808, using that information, can then represent these objects as being on the bridge and the combine module can use that information to augment the image by adding the objects to the view of the bridge.

The Gaming Module 802 provides additional interaction and effects. The Gaming Module may generate virtual characters and virtual objects to add to the augmented image. It may also provide any number of gaming effects to the virtual objects or as virtual interactions with real objects or avatars. The game play of e.g. FIGS. 4, 7A and 7B may all be provided by the Gaming Module.

The 3-D Image Interaction and Effects Module 805 tracks user interaction with real and virtual objects in the augmented images and determines the influence of objects in the z-axis (towards and away from the plane of the screen). It provides additional processing resources to provide these effects together with the relative influence of objects upon each other in three-dimensions. For example, an object thrown by a user gesture can be influenced by weather, virtual and real objects and other factors in the foreground of the augmented image, for example in the sky, as the object travels.

FIG. 9 is a block diagram of a computing system, such as a personal computer, gaming console, smart phone or portable gaming device. The computer system 900 includes a bus or other communication means 901 for communicating information, and a processing means such as a microprocessor 902 coupled with the bus 901 for processing information. The computer system may be augmented with a graphics processor 903 specifically for rendering graphics through parallel pipelines and a physics processor 905 for calculating physics interactions as described above. These processors may be incorporated into the central processor 902 or provided as one or more separate processors.

The computer system 900 further includes a main memory 904, such as a random access memory (RAM) or other dynamic data storage device, coupled to the bus 901 for storing information and instructions to be executed by the processor 902. The main memory also may be used for storing temporary variables or other intermediate information during execution of instructions by the processor. The computer system may also include a nonvolatile memory 906, such as a read only memory (ROM) or other static data storage device coupled to the bus for storing static information and instructions for the processor.

A mass memory 907 such as a magnetic disk, optical disc, or solid state array and its corresponding drive may also be coupled to the bus of the computer system for storing information and instructions. The computer system can also be coupled via the bus to a display device or monitor 921, such as a Liquid Crystal Display (LCD) or Organic Light Emitting Diode (OLED) array, for displaying information to a user. For example, graphical and textual indications of installation status, operations status and other information may be presented to the user on the display device, in addition to the various views and user interactions discussed above.

Typically, user input devices 922, such as a keyboard with alphanumeric, function and other keys, may be coupled to the bus for communicating information and command selections to the processor. Additional user input devices may include a cursor control input device such as a mouse, a trackball, a track pad, or cursor direction keys can be coupled to the bus for communicating direction information and command selections to the processor and to control cursor movement on the display 921.

Camera and microphone arrays 923 are coupled to the bus to observe gestures, record audio and video and to receive visual and audio commands as mentioned above.

Communications interfaces 925 are also coupled to the bus 901. The communication interfaces may include a modem, a network interface card, or other well known interface devices, such as those used for coupling to Ethernet, token ring, or other types of physical wired or wireless attachments for purposes of providing a communication link to support a local or wide area network (LAN or WAN), for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of the exemplary systems 800 and 900 will vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A method comprising:
gathering data from local sensors of a local device regarding a location;
receiving an archival image at the local device from a remote image store;
augmenting the archival image using the gathered data; and
displaying the augmented archival image on the local device.

2. The method of claim 1, wherein gathering data comprises determining position and present time and wherein augmenting comprises modifying the image to correspond to the present time.

3. The method of claim 2, wherein the present time comprises a date and time of day and wherein modifying the image comprises modifying the lighting and seasonal effects of the image so that it appears to correspond to the present date and time of day.

4. The method of claim 1, wherein gathering data comprises capturing images of objects that are present at the location and wherein augmenting comprises adding images of the objects to the archival image.

5. The method of claim 4, wherein objects that are present comprise nearby people and wherein adding images comprises generating avatars representing aspects of the nearby people and adding the generated avatars to the archival image.

6. The method of claim 4, wherein generating avatars comprises identifying a person among the nearby people and generating an avatar based on avatar information received from the identified person.

7. The method of claim 4, wherein generating an avatar comprises representing a facial expression of a nearby person.

8. The method of claim 1, wherein gathering data comprises gathering present weather conditions data and wherein augmenting comprises modifying the archival image to correspond to current weather conditions.

9. The method of claim 1, wherein the archival image is at least one of a satellite image, a street map image, a building plan image and a photograph.

10. The method of claim 1, further comprising generating a virtual object and wherein augmenting comprises adding the generated virtual object to the archival image.

11. The method of claim 1, further comprising receiving virtual object data from a remote user, and wherein generating comprises generating the virtual object using the received virtual object data.

12. The method of claim 11, wherein the virtual object corresponds to a message sent from the remote user to the local device.

13. The method of claim 10, further comprising receiving user input at the local device to interact with the virtual object and displaying the interaction on the augmented archival image on the local device.

14. The method of claim 10, further comprising modifying the behavior of the added virtual object in response to weather conditions.

15. The method of claim 14, wherein the weather conditions are present weather conditions received from a remote server.

16. An apparatus comprising:
local sensors to gather data regarding a location of a local device;
a communications interface to receive an archival image at the local device from a remote image sensor;
a combine module to augment the archival image using the gathered data; and
a screen rendering module to display the augmented archival image on the local device.

17. The apparatus of claim 16, Wherein the combine module is further to construct environmental conditions to augment the archival image.

18. The apparatus of claim 17, wherein the environmental conditions include clouds, lighting conditions, time of day, and date.

19. The apparatus of claim 16, further comprising a representation module to construct avatars of people and provide the avatars to the combine module to augment the archival image.

20. The apparatus of claim 19, wherein the avatars are generated using data gathered by the local sensors regarding people observed by the local sensors.

21. The apparatus of claim 19, wherein the local device is running a multiplayer game and wherein the avatars are generated based on information provided by other players of the multiplayer game.

22. The apparatus of claim 16, further comprising a user input system to allow a user to interact with a virtual object presented on the display and wherein the screen rendering module displays the interaction on the augmented archival image on the local device.

23. An apparatus comprising:
a camera to gather data regarding a location of a local device;
a network radio to receive an archival image at the local device from a remote image sensor;
a processor having a combine module to augment the archival image using the gathered data and a screen rendering module to generate a display of the augmented archival image on the local device; and
a display to display the augmented archival image to a user.

24. The apparatus of claim 24, further comprising positioning radio signal receivers to determine position and present time and wherein the combine module modifies the image to correspond to the present time including lighting and seasonal effects of the image.

25. The apparatus of claim 24, further comprising a touch interface associated with the display to receive user commands with respect to virtual objects displayed on the display, the processor further comprising a virtual object behavior module to determine behavior of the virtual objects associated with the display in response to the user commands.
